(19) United States
(12) Patent Application Publication
(10) Pub. No.: US 2026/0008401 A1
(43) Pub. Date: Jan. 8, 2026

(54) LUGGAGE STORING APPARATUS

(71) Applicant: SUBARU CORPORATION, Tokyo (JP)

(72) Inventors: Takanori TATEBE, Tokyo (JP); Naonori IKEZAWA, Tokyo (JP); Takahiro YAMAMOTO, Tokyo (JP); Sho NAGAIKE, Tokyo (JP)

(73) Assignee: SUBARU CORPORATION, Tokyo (JP)

(21) Appl. No.: 19/238,680

(22) Filed: Jun. 16, 2025

(30) Foreign Application Priority Data
Jul. 4, 2024 (JP) 2024-108517

(51) Int. Cl. B60P 1/54

(52) U.S. Cl. CPC B60P 1/5423

(57) ABSTRACT

A luggage storing apparatus configured to store luggage into a luggage compartment of a vehicle includes: a first winder provided to a ceiling of the luggage compartment or a cabin; a second winder provided to the ceiling, a support member; a string-shaped member suspended from the first winder to the second winder via the support member; an attachment member configured to attach the luggage to the string-shaped member, and a stopper mechanism configured to restrict closing operation of the rear gate. While the rear gate is open and the closing operation of the rear gate is restricted, the first winder winds up one end of the string-shaped member to lift the luggage. Then, the first winder sends out the one end of the string-shaped member and the second winder winds up the other end of the string-shaped member to take the luggage into the luggage compartment.

### CROSS-REFERENCE TO RELATED APPLICATIONS

The present application claims priority from Japanese Patent Application No. 2024-108517 filed on Jul. 4, 2024, the entire contents of which are hereby incorporated by reference.

### BACKGROUND

The disclosure relates to a luggage storing apparatus.

When a user of a private vehicle or the like stores luggage that has been placed on a cart or a wheeled platform into a luggage compartment, the user lifts and moves the luggage manually. This may be burdensome for the user depending on a size or weight of the luggage. With regard to this, in a known technology, luggage is automatically loaded into a luggage compartment of a vehicle.

### SUMMARY

An aspect of the disclosure provides a luggage storing apparatus configured to store luggage into a luggage compartment of a vehicle. The luggage storing apparatus includes a first winder, a second winder, a support member, a string-shaped member, an attachment member, and a stopper mechanism. The first winder is provided to a ceiling of the luggage compartment or a cabin of the vehicle. The second winder is provided to the ceiling. The support member is provided to an inner surface of a rear gate of the vehicle. The string-shaped member is suspended from the first winder to the second winder via the support member. The attachment member is configured to attach the luggage to the string-shaped member suspended between the support member and the second winder. The stopper mechanism is configured to restrict closing operation of the rear gate. The first winder is configured to wind up or send out a first end of the string-shaped member. The second winder is configured to wind up or send out a second end of the string-shaped member. The first winder and the second winder are configured such that while the rear gate is open and the closing operation of the rear gate is restricted by the stopper mechanism, the first winder winds up the first end of the string-shaped member to lift the luggage to a lower side of the rear gate by using the support member as a fulcrum, then, the first winder sends out the first end of the string-shaped member and the second winder winds up the second end of the string-shaped member to take the luggage into the luggage compartment from the lower side of the rear gate.

An aspect of the disclosure provides a luggage storing apparatus configured to store luggage into a luggage compartment of a vehicle. The luggage storing apparatus includes at least one processor, a first winder, a second winder, a support member, a string-shaped member, an attachment member, and a stopper mechanism. The first winder is provided to a ceiling of the luggage compartment or a cabin of the vehicle. The second winder is provided to the ceiling. The support member is provided to an inner surface of a rear gate of the vehicle. The string-shaped member is suspended from the first winder to the second winder via the support member. The attachment member is configured to attach the luggage to the string-shaped member suspended between the support member and the second winder. The at least one processor is configured to, while the rear gate is open and the at least one processor causes the stopper mechanism to restrict closing operation of the rear gate, cause the first winder to wind up a first end of the string-shaped member to lift the luggage to a lower side of the rear gate by using the support member as a fulcrum, and then cause the first winder to send out the first end of the string-shaped member and cause the second winder to wind up a second end of the string-shaped member to take the luggage into the luggage compartment from the lower side of the rear gate.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIGS. 1A and 1B are schematic views illustrating a schematic configuration of a luggage storing apparatus according to an embodiment of the disclosure.

FIGS. 2A to 2C are schematic views illustrating a configuration of a winder according to the embodiment.

FIGS. 3A and 3B are schematic views illustrating a configuration of a rear gate damper according to the embodiment.

FIG. 4 is a block diagram illustrating an example of a hardware configuration of a control device according to the embodiment.

FIGS. 5A to 5C are schematic views illustrating operation of the luggage storing apparatus to load luggage according to the embodiment.

FIGS. 6A and 6B are schematic views illustrating operation of the luggage storing apparatus to load luggage according to the embodiment.

FIGS. 7A to 7C are schematic views illustrating operation of the luggage storing apparatus to unload luggage according to the embodiment.

FIGS. 8A and 8B are schematic views illustrating operation of the luggage storing apparatus to unload luggage according to the embodiment.

### DETAILED DESCRIPTION

For example, Japanese Unexamined Patent Application Publication (JP-A) No. 1996-091109 discloses a vehicle-mounted crane as a crane for loading and unloading luggage in a small-sized van. The vehicle-mounted crane includes a boom base that can be moved in various directions of the vehicle, a turnable boom, a fixed boom, a movable boom, and a winch that winds up wire coupled to luggage. In the vehicle-mounted crane in JP-A No. 1996-091109, the winch winds up the wire to lift up the luggage in a state in which the movable boom is moved to a vehicle rear side, and then the movable boom is moved to a vehicle front side, so that the luggage is stored in a luggage compartment.

Moreover, JP-A No. 2001-334861 discloses a luggage lift apparatus including a rotary arm rotatable with respect to a bracket provided to an upper side in a luggage compartment, and a drive unit that winds up a belt coupled to luggage. In the luggage lift apparatus in JP-A No. 2001-334861, the drive unit winds up the belt to lift up the luggage in a state in which the rotary arm is rotated to a vehicle rear side, and then the rotary arm is rotated to a vehicle front side, so that the luggage is stored in the luggage compartment.

However, known luggage carriers described in JP-A No. 1996-091109, JP-A No. 2001-334861, and the like have a problem that they use a turnable or slidable, movable boom, and a carriage mechanism itself becomes large in scale in order to, for example, move and support the boom. When the carriage mechanism itself is large in scale, in application to a private vehicle or the like, space inside the luggage compartment is taken up, and there is room for improvement in that an amount of luggage storable in the luggage compartment may decrease. Accordingly, there has been a demand for a luggage storing apparatus with a simpler mechanism for use in a private vehicle or the like.

Therefore, it is desirable to provide a luggage storing apparatus that makes it possible to easily store luggage in a luggage compartment, with a simple configuration without use of a movable boom.

An embodiment of the disclosure is described below in detail with reference to the accompanying drawings. Specific dimensions, materials, numerical values, and the like presented in the embodiment are merely illustration for facilitating understanding of the embodiment of the disclosure, and are not intended to limit the embodiment of the disclosure unless otherwise specified. Relative sizes of components illustrated in each drawing do not necessarily represent a precise size relationship between the actual components. Note that, in the specification and the drawings, the same reference characters are given to elements having substantially the same functions or configurations to omit redundant description. Moreover, illustration of elements that are not directly related to the embodiment of the disclosure is omitted.

### Outline of Luggage Storing Apparatus 1

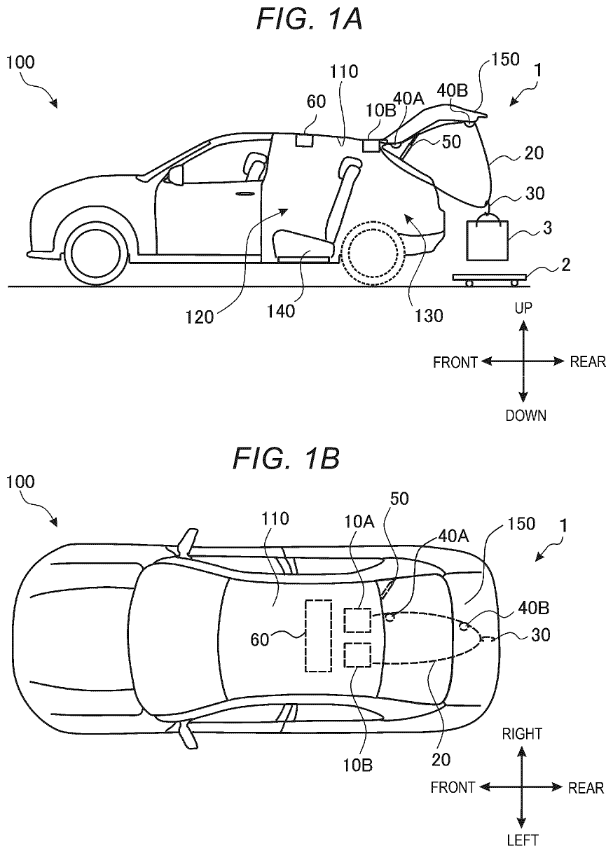

FIGS. 1A and 1B are schematic views illustrating a schematic configuration of a luggage storing apparatus 1 according to an embodiment of the disclosure. FIG. 1A is a side view illustrating a vehicle 100 where the luggage storing apparatus 1 is provided. FIG. 1B is a plan view illustrating the vehicle 100 where the luggage storing apparatus 1 is provided. Below, as indicated by arrows in FIGS. 1A and 1B, a travel direction of the vehicle 100 when moving forward is referred to as a front direction, and a travel direction of the vehicle 100 when moving backward is referred to as a rear direction. Moreover, when seen from the rear direction of the vehicle 100, a right side of the vehicle 100 in a width direction is referred to as a right direction, and a left-side direction of the vehicle 100 in the width direction is referred to as a left direction. Moreover, a vertically up direction is referred to as an up direction, and a vertically down direction is referred to as a down direction.

The luggage storing apparatus 1 according to this embodiment is, for example, an apparatus that is additionally provided to a rear portion of the vehicle 100 in an optional way and used for carrying luggage 3. The luggage storing apparatus 1 can load the luggage 3 placed outside of the vehicle 100 into a luggage compartment 130 at the rear portion of the vehicle 100. The luggage storing apparatus 1 can also unload the luggage 3 stored in the luggage compartment 130 to the outside of the vehicle 100.

For example, in some embodiments, the vehicle 100 to which the luggage storing apparatus 1 is applied is a hatchback passenger vehicle including the comparatively large luggage compartment 130 and a large rear gate 150 for opening and closing the luggage compartment 130 as illustrated in FIGS. 1A and 1B. However, the vehicle to which the luggage storing apparatus 1 is applied is not limited to the above-mentioned examples, and may be, for example, a passenger vehicle, such as a sedan, a one-box vehicle, an SUV, and a compact vehicle, or may be a commercial vehicle, such as a truck and a bus, or a cargo vehicle. The luggage 3 is various types of articles that can be carried by the vehicle 100. The luggage 3 may have any size or shape as long as the luggage 3 is an article storable in the luggage compartment 130 of the vehicle 100. The luggage compartment 130 is a space on a rear side of a rear seat 140 in an internal space of the vehicle 100 and is a so-called trunk room that stores luggage.

### Configuration of Luggage Storing Apparatus 1

As illustrated in FIGS. 1A and 1B, the luggage storing apparatus 1 includes a first winder 10A, a second winder 10B, a wire 20, a hook 30, a support roller 40A, 40B, a rear gate damper 50, and a control device 60.

The first winder 10A and the second winder 10B are devices that can wind up or send out the wire 20, and include, for example, small-sized winches. The first winder 10A and the second winder 10B wind up or send out the wire 20 to move the luggage 3 coupled to the wire 20 via the hook 30.

The first winder 10A and the second winder 10B are provided to a ceiling 110 of a cabin 120 or the luggage compartment 130 of the vehicle 100. For example, as illustrated in FIGS. 1A and 1B, the first winder 10A and the second winder 10B are provided to the ceiling 110 between the rear seat 140 and a middle portion of the luggage compartment 130. Here, the cabin 120 is a space where an occupant has a seat in the internal space of the vehicle 100, and is, for example, a space on a front side of the rear seat 140. The first winder 10A and the second winder 10B are provided to the ceiling 110 of the luggage compartment 130 on the rear side of the rear seat 140, and thus, the first winder 10A and the second winder 10B do not take up space around a head of an occupant at the rear seat 140.

In some embodiments, as illustrated in FIG. 1B, the first winder 10A and the second winder 10B are provided side by side in the left-right direction. However, without being limited to such an example, the first winder 10A and the second winder 10B are not necessarily provided side by side in the left-right direction, and may be, for example, provided side by side in the front-rear direction or an oblique direction as long as the first winder 10A and the second winder 10B are provided to the ceiling 110 of the cabin 120 or the luggage compartment 130. Alternatively, instead of the first winder 10A and the second winder 10B being configured as separate bodies, they may be permanently affixed inside the same housing. Note that details of configurations of the first winder 10A and the second winder 10B will be described later with reference to another drawing. Below, the first winder 10A and the second winder 10B may correctively be referred to as a “winder 10”.

The wire 20 is one example of a string-shaped member that is wound up or sent out by the first winder 10A and the second winder 10B. The wire 20 is provided in such a manner as to be suspended between the first winder 10A and the second winder 10B. For example, one end of the wire 20 is coupled to the first winder 10A and the other end of the wire 20 is coupled to the second winder 10B. Although in this embodiment the wire 20 is used as one example of the string-shaped member, the string-shaped member is not limited to this example. For example, a belt, a chain, a rope, a string, a band, or the like may be used instead of the wire 20 as the string-shaped member.

The hook 30 is one example of an attachment member that attaches the luggage 3 to the wire 20. The hook 30 is an engagement member that hooks the luggage 3 to the wire 20. The hook 30 is detachably attached to the wire 20. For example, the hook 30 is provided to an approximately intermediate portion of the wire 20 suspended between the support roller 40B and the second winder 10B. One end of the hook 30 is coupled to the wire 20. A user hooks the other end of the hook 30 to the luggage 3, thereby attaching the luggage 3 to the wire 20. In this embodiment, as one example of the attachment member, as illustrated in FIGS. 1A and 1B, the hook 30 that can easily be hooked to a handle of the luggage 3 is used. However, the attachment member is not limited to this example. The attachment member may be, for example, a zip tie, a hook-and-loop fastener tape, a carabiner, a packing rope, or the like capable of attaching the luggage 3 to the wire 20 in a detachable manner. Moreover, in some embodiments, the hook 30 is detachable from the wire 20, and an appropriate hook 30 can be used in accordance with the shape and size of the luggage 3.

The support roller 40A, 40B is one example of a support member that supports the wire 20 along an inner surface (a side surface on the luggage compartment 130 side) of the rear gate 150. The support roller 40A, 40B includes, for example, a pulley-shaped support member having a rotatable roller. The support roller 40A, 40B supports the wire 20 not to droop down from the rear gate 150 while guiding motion of the wire 20.

The support roller 40A, 40B is provided to the inner surface of the rear gate 150. The support roller 40B is disposed at a position closer to a free end (tip end) of the rear gate 150 with respect to the support roller 40A. For example, the support roller 40A is provided to the inner surface of the rear gate 150 at a position closer to a fulcrum (base) in open-close operation of the rear gate 150. The support roller 40B is provided between a middle portion of the rear gate 150 and the free end (tip end) of the rear gate 150. The support roller 40A, 40B is rotatable in a direction in which the wire 20 is wound up or sent out, and rotates in accordance with winding up or sending out of the wire 20 while supporting the wire 20 between the first winder 10A and the hook 30.

As described above, in this embodiment, as illustrated in FIGS. 1A and 1B, the two support rollers 40A and 40B that serve as guide rollers for the moving wire 20 as well as serving as fulcrums for hanging the luggage 3 are used as one example of the support member. However, the support member is not limited to this example. The support member may variously be changed as long as the support member does not impede movement of the string-shaped member such as the wire 20 as the string-shaped member is wound up or sent out, and can support the string-shaped member such as the wire 20. For example, the support member may be an engagement member, such as a hook, a projection, and an annular guide, projecting from the inner surface of the rear gate 150 toward the luggage compartment 130 and capable of hooking the string-shaped member thereto, or may be a rotatable member in a drum shape or a reel shape. Further, in this embodiment, two support members (the support rollers 40A and 40B) are used as one example of the support member. However, the support member is not limited to this example. The support member may include, for example, a singe support member (for example, only the support roller 40B) used as long as the support member can support the string-shaped member such as the wire 20 during storing of luggage. Moreover, in order to stably support the wire 20, three or more support members may be provided. For example, an additional third support roller may be provided between the support roller 40A and the support roller 40B.

The rear gate damper 50 includes a stopper mechanism 500 that restricts closing operation in which the rear gate 150 of the vehicle 100 turns from an open state to a closed state. The rear gate damper 50 is a damper that is extendable and contractible in accordance with open-close operation of the rear gate 150. The rear gate damper 50 is provided between a vehicle body and the rear gate 150 of the vehicle 100. The rear gate damper 50 is extended when the rear gate 150 is in the open state. The rear gate damper 50 is contracted when the rear gate 150 is in the closed state. For example, when the stopper mechanism 500 operates with respect to the extended rear gate damper 50, the rear gate damper 50 remains in the extended state. Accordingly, the rear gate 150 remains in the open state, and closing operation is restricted. Note that the configuration of the rear gate damper 50 will be described later with reference to another drawing.

The control device 60 controls operation of each member of the luggage storing apparatus 1. For example, the control device 60 can communicate with the first winder 10A, the second winder 10B, and the rear gate damper 50 in a wireless or wired manner, and controls operation of the first winder 10A, the second winder 10B, and the rear gate damper 50. For example, the control device 60 controls operation of the first winder 10A and the second winder 10B to wind up or send out the wire 20. The control device 60 also controls operation of the stopper mechanism 500 of the rear gate damper 50.

### Configuration of Winder 10

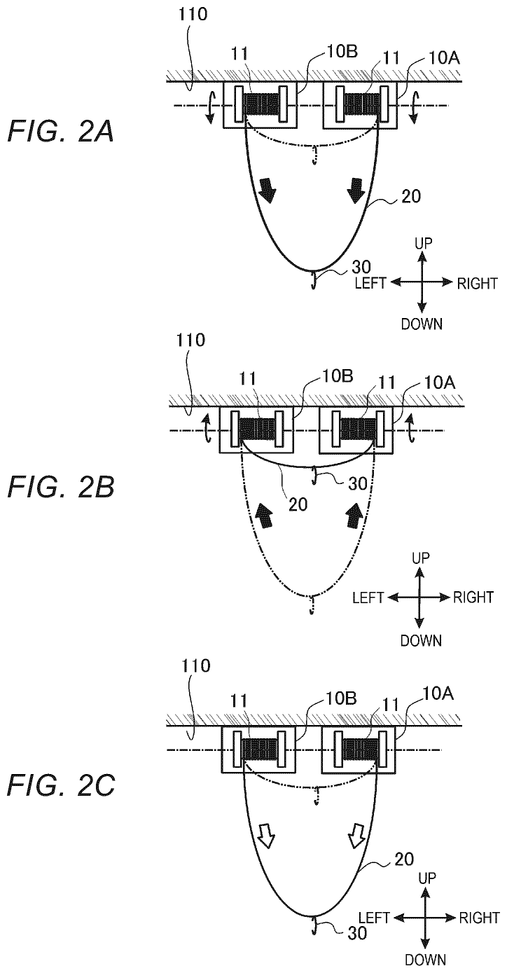

FIGS. 2A to 2C are schematic views illustrating a configuration of the winder 10 according to this embodiment. FIGS. 2A and 2B are schematic views illustrating a driven state of the winder 10. FIG. 2C is a schematic view illustrating a manual state of the winder 10.

Each winder 10 includes a drum 11 and a motor not illustrated. The drum 11 is a rotary member that rotates about a rotational axis extending in the left-right direction. The drum 11 rotates by being driven by the motor, and thus winds up or sends out the wire 20. The motor is one example of a driving device that generates driving force to rotate the drum 11, and is, for example, an electric motor. The driving of the motor is controlled by the control device 60. Below, a state in which the motor is driven in the winder 10 is referred to as a driven state. A state in which the motor is not driven in the winder 10 is referred to as a manual state. Note that switching between the driven state and the manual state of the winder 10 is controlled by the control device 60.

As illustrated in FIG. 2A, the one end of the wire 20 is wound around the drum 11 of the first winder 10A. The first winder 10A rotates the drum 11 in a positive direction to send out the one end of the wire 20. Moreover, the other end of the wire 20 is wound around the drum 11 of the second winder 10B. The second winder 10B rotates the drum 11 in the positive direction to send out the wire 20. For example, when the drums 11 of the first winder 10A and the second winder 10B both rotate in the positive direction, both ends of the wire 20 are sent out, and thereby the wire 20 wound around the two drums 11 is drawn out.

As illustrated in FIG. 2B, the first winder 10A rotates the drum 11 in a reverse direction to wind up the one end of the wire 20. Moreover, the second winder 10B rotates the drum 11 in the reverse direction to wind up the wire 20. For example, when the drums 11 of the first winder 10A and the second winder 10B both rotate in the reverse direction, both ends of the wire 20 are wound up, and thereby the wire 20 is wound around the two drums 11.

As illustrated in FIG. 2C, when the first winder 10A and the second winder 10B are in the manual state in which the motors are not driven, a user can manually draw out the wire 20. For example, when the luggage 3 is not suspended from the wire 20 via the hook 30, that is, when the luggage storing apparatus 1 is not used, the first winder 10A and the second winder 10B are in the manual state. In the manual state, the drums 11 of the first winder 10A and the second winder 10B are uncoupled from the motors and are in a rotatable, free state. Therefore, when using the luggage storing apparatus 1, a user can easily draw out the wire 20 wound around the two drums 11 and can attach the hook 30 that has been attached to the drawn-out wire 20 to the luggage 3.

Moreover, when the first winder 10A and the second winder 10B are in the manual state, the drawn-out wire 20 may automatically be wound around the two drums 11 as a load in a drawing-out direction is no longer present. When the drawn-out wire 20 is automatically wound up, force to rotate the drum 11 in the winding-up direction of the wire 20 is elastic force based on an elastic body such as a spring or rubber. Therefore, when the luggage storing apparatus 1 is not used, the wire 20 is compactly stored in such a manner that a great portion of the wire 20 is wound around the drums 11, that is, the approximately intermediate portion of the wire 20 is in contact with the first winder 10A and the second winder 10B.

### Configuration of Rear Gate Damper 50

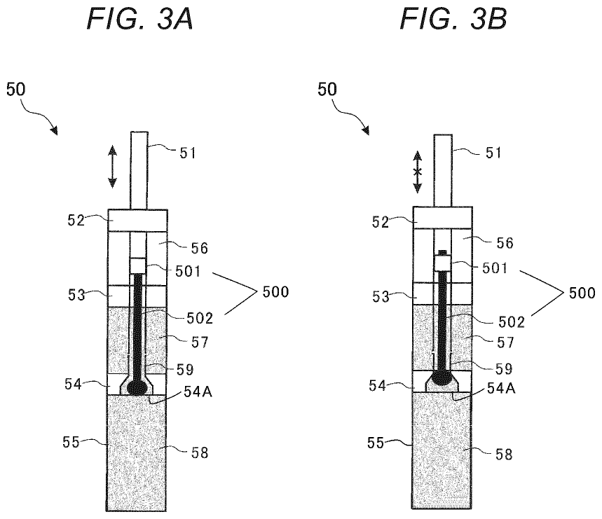

FIGS. 3A and 3B are schematic views illustrating a configuration of the rear gate damper 50 according to this embodiment. FIG. 3A is a schematic view illustrating the rear gate damper 50 with the stopper mechanism 500 stopped. FIG. 3B is a schematic view illustrating the rear gate damper 50 with the stopper mechanism 500 operating.

As illustrated in FIGS. 3A and 3B, the rear gate damper 50 includes a rod 51, a guide 52, a free piston 53, a piston 54, and a container 55. The rod 51 is inserted into the guide 52 and the free piston 53, and has a tip end provided with the piston 54. The guide 52 is provided to an opening of the container 55 to seal the container 55. The free piston 53 is provided to be movable in the up-down direction along the rod 51. In the container 55, a space 56 between the guide 52 and the free piston 53 is filled with gas. Moreover, in the container 55, a space 58 below the piston 54 is filled with oil.

The piston 54 is provided with a hole 54A. As the oil transfers between a space 57 and the space 58 through the hole 54A of the piston 54 and a channel 59, the free piston 53 moves in the up-down direction. As the free piston 53 moves, the gas filled in the space 56 is compressed or expanded, and thereby the rod 51 moves in the up-down direction. That is, the rear gate damper 50 has a gas-spring structure. The rear gate damper 50 extends as the rod 51 moves upward, and makes the rear gate 150 be the open state. Moreover, the rear gate damper 50 contracts as the rod 51 moves downward, and makes the rear gate 150 be the closed state.

The gas-spring rear gate damper 50 according to this embodiment further includes the stopper mechanism 500. As illustrated in FIGS. 3A and 3B, the stopper mechanism 500 includes a solenoid 501 and a push rod 502. The solenoid 501 moves the push rod 502 in the up-down direction.

As illustrated in FIG. 3A, when the stopper mechanism 500 is in a stopped state, the oil is transferable between the space 57 and the space 58, and the rod 51 can be extended or contracted. On the other hand, as illustrated in FIG. 3B, when the stopper mechanism 500 operates, the solenoid 501 moves the push rod 502 upward to close the channel 59. Accordingly, transferring of the oil between the space 57 and the space 58 is restricted. As a result, the oil filling the space 58 restricts the motion of the free piston 53, and a position of the rod 51 is maintained. That is, when the stopper mechanism 500 operates, extension and contraction of the rear gate damper 50 stops at this time point, and the rear gate 150 remains in the open state or closed state. Note that operation of the stopper mechanism 500 is controlled by the control device 60.

### Configuration of Control Device 60

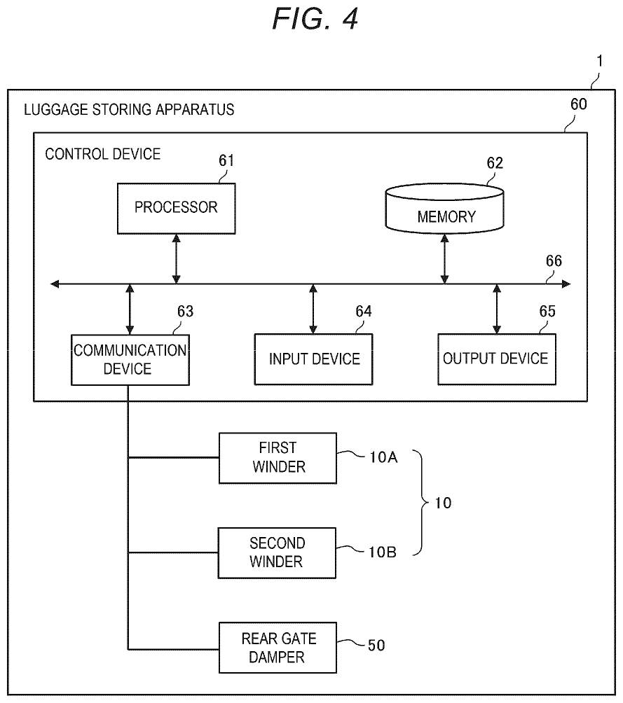

FIG. 4 is a block diagram illustrating one example of a hardware configuration of the control device 60 of the luggage storing apparatus 1 according to this embodiment.

As illustrated in FIG. 4, the control device 60 includes one or more processors 61, one or more memories 62, a communication device 63, an input device 64, an output device 65, and a bus 66.

The processor 61 is an arithmetic processor installed on a computer. The memory 62 includes a ROM (read only memory) storing a program or the like, and a RAM (random access memory) as a work area. The processor 61 executes the program stored in the memory 62, thereby controlling the luggage storing apparatus 1. For example, the processor 61 controls operation of the first winder 10A and the second winder 10B to wind up or send out the wire 20. The processor 61 also controls operation of the stopper mechanism 500 of the rear gate damper 50.

The communication device 63 is a device to communicate with an external device coupled to the control device 60 in a wired or wireless manner. For example, the communication device 63 communicates with the winder 10 and the rear gate damper 50.

The input device 64 is a device used by a user to input information to the control device 60. The input device 64 includes, for example, a touch sensor, a remote controller, a button, a switch, or a dial. The input device 64 may include an input device for audio input, such as a microphone and a speech recognition module. For example, when the input device 64 receives user input operation related to loading operation or unloading operation of the luggage 3 (for example, operation to instruct a start of loading the luggage 3), the input device 64 transmits to the processor 61 an input signal corresponding to the input operation.

The output device 65 is a device that outputs information and/or data to the outside of the control device 60. The output device 65 includes a display that displays information, such as text, a figure, and an image, and an audio output device that outputs audio. For example, the output device 65 outputs information related to loading operation or unloading operation of the luggage 3 (for example, information indicating an end of operation for loading the luggage 3).

The processor 61, the memory 62, the communication device 63, the input device 64, and the output device 65 are coupled to one another via the bus 66. Accordingly, transmission and reception of various information and/or data are possible between these devices.

### Operation 1 of Luggage Storing Apparatus 1

As described above, the luggage storing apparatus 1 carries the luggage 3 coupled to the wire 20 via the hook 30 as the winder 10 winds up or sends out the wire 20. For example, the luggage storing apparatus 1 can load the luggage 3 placed outside of the vehicle 100 into the luggage compartment 130. Here, the luggage 3 located outside of the vehicle 100 may be placed on, for example, a cart, a wheeled platform, or the ground, or may be held in a hand of a person (for example, a user). Below, operation of the luggage storing apparatus 1 to load the luggage 3 from a wheeled platform 2 into the luggage compartment 130 is described while taking, as an example, a case where the luggage 3 has been placed on the wheeled platform 2.

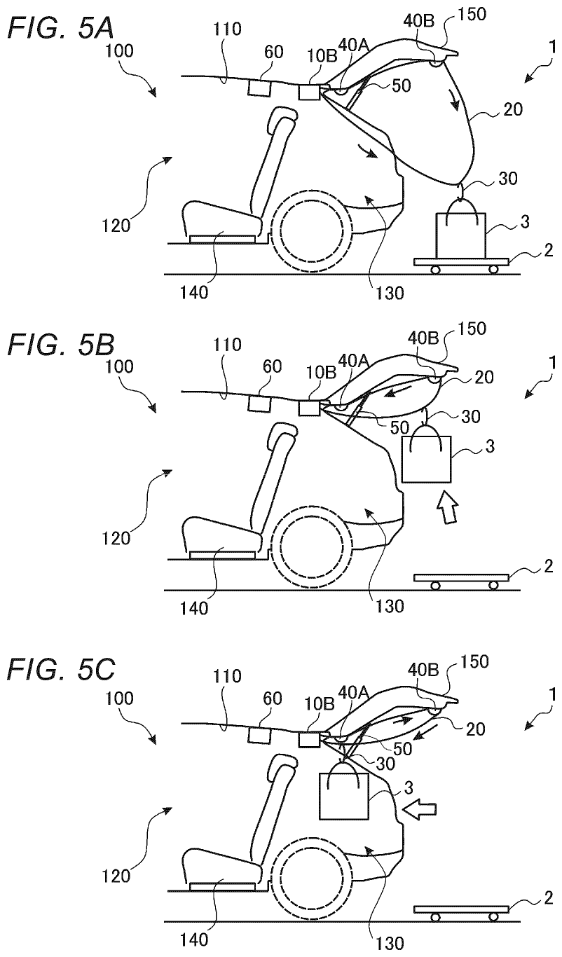

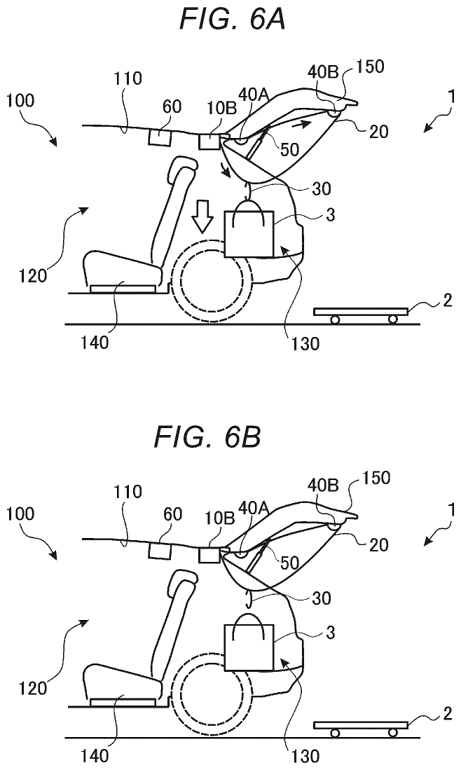

FIGS. 5A to 5C, 6A, and 6B are schematic views illustrating operation of the luggage storing apparatus 1 to load the luggage 3. FIGS. 5A to 5C, 6A, and 6B illustrate transition of the operation of the luggage storing apparatus 1 to load the luggage 3 that has been placed on the wheeled platform 2 into the luggage compartment 130.

First, as illustrated in FIG. 5A, the luggage storing apparatus 1 causes the stopper mechanism 500 to operate with respect to the rear gate 150 in the open state. Accordingly, the stopper mechanism 500 restricts the closing operation of the rear gate 150, and the rear gate 150 can be locked so as not to be closed by a load of the lifted luggage 3. Then, a user manually draws out the wire 20 from the first winder 10A and the second winder 10B both in the manual state and attaches the hook 30 to the luggage 3.

Next, as illustrated in FIG. 5B, the first winder 10A of the luggage storing apparatus 1 winds up the one end of the wire 20 to lift the luggage 3 from the wheeled platform 2 to a lower side of the rear gate 150 by using the support roller 40B as a fulcrum. At this time, the second winder 10B is in a locked state in which the motor is not driven and drawing of the wire 20 is restricted.

For example, a wind-up amount of the wire 20 by the first winder 10A to lift the luggage 3 to the lower side of the rear gate 150 is determined in advance. The wind-up amount is a length of the wire 20 to be wound up. The control device 60 causes the motor of the first winder 10A to be driven to reach the wind-up amount determined in advance for the first winder 10A and causes the one end of the wire 20 to be wound up, so that the luggage 3 is lifted to the lower side of the rear gate 150. Here, a specific example of the wind-up amount determined in advance includes a wind-up amount for lifting the luggage 3 so that a lower end of the luggage 3 with the maximum size to be storable in the luggage compartment 130 is positioned higher than a floor of the luggage compartment 130.

Note that, during lifting of the luggage 3 to the lower side of the rear gate 150 as illustrated in FIG. 5B, the stopper mechanism 500 is ongoingly in operation. Therefore, the rear gate damper 50 remains in the extended state, and closing operation of the rear gate 150 is restricted, and thereby the rear gate 150 is not closed by a load of the lifted luggage 3.

Next, as illustrated in FIG. 5C, as the first winder 10A of the luggage storing apparatus 1 sends out the one end of the wire 20 while the second winder 10B winds up the other end of the wire 20, the lifted luggage 3 is moved forward to be taken into the luggage compartment 130 from the lower side of the rear gate 150. For example, a wind-up amount of the wire 20 by the second winder 10B to take the luggage 3 that has been lifted to the lower side of the rear gate 150 into the luggage compartment 130 is determined in advance. Moreover, a send-out amount of the wire 20 by the first winder 10A is determined in advance to be the same amount as the wind-up amount by the second winder 10B. The control device 60 causes the motor of the second winder 10B to be driven to reach the wind-up amount determined in advance for the second winder 10B and causes the other end of the wire 20 to be wound up, while causing the motor of the first winder 10A to be driven to reach the send-out amount determined in advance for the first winder 10A and causes the one end of the wire 20 to be sent out. Accordingly, the luggage 3 is taken into the luggage compartment 130 from the lower side of the rear gate 150. Here, a specific example of the send-out amount and the wind-up amount determined in advance includes a send-out amount and a wind-up amount for moving forward the luggage 3 so that the hook 30 is positioned at an approximate middle in the front-rear direction of the luggage compartment 130.

Note that in a case where the motors of the first winder 10A and the second winder 10B can be driven in an interlocking manner, one of the send-out amount by the first winder 10A and the wind-up amount by the second winder 10B may be set in advance. As the first winder 10A sends out the wire 20 and the second winder 10B winds up the wire 20 in the interlocking manner, the luggage 3 is taken into the luggage compartment 130 from the lower side of the rear gate 150.

Note that, during taking of the lifted luggage 3 from the lower side of the rear gate 150 into the luggage compartment 130, the stopper mechanism 500 is ongoingly in operation. Therefore, the rear gate damper 50 remains in the extended state, and the rear gate 150 is not closed by a load of the suspended luggage 3.

Next, as illustrated in FIG. 6A, as the first winder 10A of the luggage storing apparatus 1 sends out the one end of the wire 20 while the second winder 10B sends out the other end of the wire 20, the luggage 3 is placed on the floor of the luggage compartment 130. For example, a send-out amount of the wire 20 by the first winder 10A and the second winder 10B to place the luggage 3 on the floor of the luggage compartment 130 is determined in advance. The control device 60 causes the motors of the first winder 10A and the second winder 10B to be driven to reach the send-out amount determined in advance for the first winder 10A and the second winder 10B and causes both ends of the wire 20 to be sent out. Accordingly, the luggage 3 is placed on the floor of the luggage compartment 130. Here, a specific example of the send-out amount determined in advance includes a send-out amount that makes a distance between the first winder 10A or the second winder 10B and the hook 30 equal to a width of the luggage compartment 130 in the up-down direction.

The control device 60 may cause the first winder 10A and the second winder 10B to be the manual state to place the luggage 3 on the floor of the luggage compartment 130. When the control device 60 causes the first winder 10A and the second winder 10B to be the manual state, the wire 20 is drawn out by a load of the luggage 3. Accordingly, the luggage 3 is placed on the floor of the luggage compartment 130.

Note that, during placing of the luggage 3 on the floor of the luggage compartment 130, the stopper mechanism 500 is ongoingly in operation. Therefore, the rear gate damper 50 remains in the extended state, and the rear gate 150 is not closed by a load of the suspended luggage 3.

Next, as illustrated in FIG. 6B, after the luggage 3 is placed on the floor of the luggage compartment 130, a user removes the hook 30 from the luggage 3. The control device 60 also stops the stopper mechanism 500 and causes the rear gate damper 50 to be a contractible state. Accordingly, the rear gate 150 becomes a closeable state, and the loading operation of the luggage 3 ends.

As described above, the luggage storing apparatus 1 loads the luggage 3 from the wheeled platform 2 into the luggage compartment 130 by the control device 60 controlling operation of the first winder 10A and the second winder 10B. For example, the first winder 10A winds up the one end of the wire 20 based on the wind-up amount determined in advance, thus lifting the luggage 3 to the lower side of the rear gate 150 and then taking the luggage 3 into the luggage compartment 130. Accordingly, the luggage storing apparatus 1 can take the luggage 3 into the luggage compartment 130 without contacting a bumper of the vehicle 100. Moreover, the wind-up amount and the send-out amount of the wire 20 by the first winder 10A and the second winder 10B are determined in advance. Accordingly, even the luggage 3 with various shapes or sizes can be loaded into the luggage compartment 130. Moreover, in the luggage storing apparatus 1, the first winder 10A and the second winder 10B are provided to the ceiling 110 between the rear seat 140 and the middle portion of the luggage compartment 130. Accordingly, the luggage 3 can be drawn in to the rear seat 140 side of the luggage compartment 130. As a result, when the luggage compartment 130 is seen from the rear side of the vehicle 100, the luggage 3 can be loaded in order from a far side.

### Operation 2 of Luggage Storing Apparatus 1

As described above, the luggage storing apparatus 1 carries the luggage 3 coupled to the wire 20 via the hook 30 as the winder 10 winds up or sends out the wire 20. For example, the luggage storing apparatus 1 can unload the luggage 3 stored in the luggage compartment 130 of the vehicle 100 to the outside of the vehicle 100. Below, operation of the luggage storing apparatus 1 to unload the luggage 3 stored in the luggage compartment 130 onto the wheeled platform 2 positioned outside of the vehicle 100 is described.

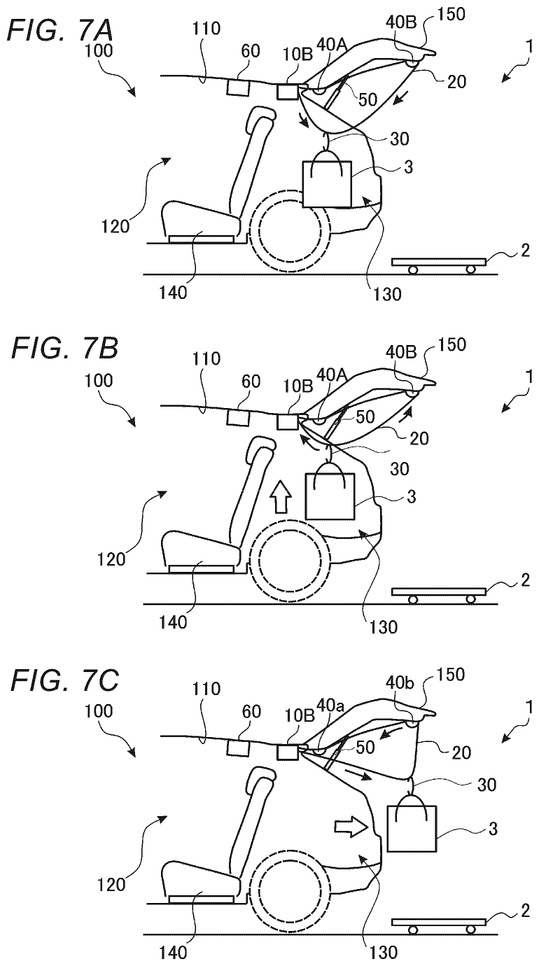

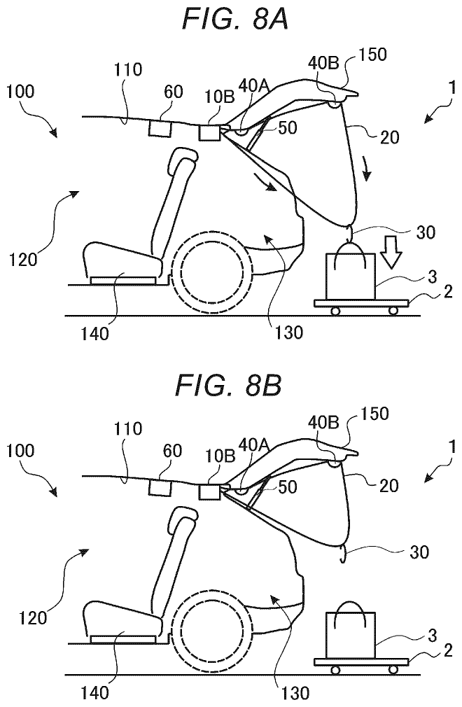

FIGS. 7A to 7C, 8A, and 8B are schematic views illustrating operation of the luggage storing apparatus 1 to unload the luggage 3. FIGS. 7A to 7C, 8A, and 8B illustrate transition of the operation of the luggage storing apparatus 1 to unload the luggage 3 that has been placed on the floor of the luggage compartment 130 onto the wheeled platform 2.

First, as illustrated in FIG. 7A, the luggage storing apparatus 1 causes the stopper mechanism 500 to operate with respect to the rear gate 150 in the open state. Accordingly, the stopper mechanism 500 restricts closing operation of the rear gate 150, and the rear gate 150 can be locked so as not to be closed by a load of the lifted luggage 3. Then, a user manually draws out the wire 20 from the first winder 10A and the second winder 10B both in the manual state and attaches the hook 30 to the luggage 3.

Next, as illustrated in FIG. 7B, as the first winder 10A of the luggage storing apparatus 1 winds up the one end of the wire 20 while the second winder 10B winds up the other end of the wire 20, the luggage 3 is lifted. Here, the luggage 3 may simply be lifted to an extend that allows the bottom of the luggage 3 not to contact the floor of the luggage compartment 130.

Note that, during lifting of the luggage 3 as illustrated in FIG. 7B, the stopper mechanism 500 is ongoingly in operation. Therefore, the rear gate damper 50 remains in the extended state, and closing operation of the rear gate 150 is restricted, and thereby the rear gate 150 is not closed by a load of the lifted luggage 3.

Next, as illustrated in FIG. 7C, as the first winder 10A of the luggage storing apparatus 1 winds up the one end of the wire 20 while the second winder 10B sends out the other end of the wire 20, the lifted luggage 3 is moved rearward to be drawn out from the luggage compartment 130 to the lower side of the rear gate 150. For example, a wind-up amount of the wire 20 by the first winder 10A to draw out the lifted luggage 3 from the luggage compartment 130 to the lower side of the rear gate 150 is determined in advance. Moreover, a send-out amount of the wire 20 by the second winder 10B is determined in advance to be the same amount as the wind-up amount by the first winder 10A. The control device 60 causes the motor of the first winder 10A to be driven to reach the wind-up amount determined in advance for the first winder 10A and causes the one end of the wire 20 to be wound up, while causing the motor of the second winder 10B to be driven to reach the send-out amount determined in advance for the second winder 10B and causes the other end of the wire 20 to be sent out. Accordingly, the lifted luggage 3 is drawn out from the luggage compartment 130 to the lower side of the rear gate 150. Here, a specific example of the wind-up amount and the send-out amount determined in advance includes a wind-up amount and a send-out amount that make the hook 30 be positioned at the lower side the rear gate 150.

Note that in the case where the motors of the first winder 10A and the second winder 10B can be driven in an interlocking manner, one of the wind-up amount by the first winder 10A and the send-out amount by the second winder 10B may be set in advance. As the first winder 10A winds up the wire 20 and the second winder 10B draws out the wire 20 in the interlocking manner, the luggage 3 is drawn out from the luggage compartment 130 to the lower side of the rear gate 150.

Note that, during drawing of the luggage 3 out of the luggage compartment 130 to the lower side of the rear gate 150, the stopper mechanism 500 is ongoingly in operation. Therefore, the rear gate damper 50 remains in the extended state, and the rear gate 150 is not closed by a load of the suspended luggage 3.

Next, as illustrated in FIG. 8A, as the first winder 10A of the luggage storing apparatus 1 sends out the one end of the wire 20 while the second winder 10B sends out the other end of the wire 20, the luggage 3 is unloaded onto the wheeled platform 2. For example, a send-out amount of the wire 20 by the first winder 10A and the second winder 10B to place the luggage 3 on the wheeled platform 2 is determined in advance. The control device 60 causes the motors of the first winder 10A and the second winder 10B to be driven to reach the send-out amount determined in advance for the first winder 10A and the second winder 10B and causes both ends of the wire 20 to be sent out. Accordingly, the luggage 3 is placed on the wheeled platform 2. Here, a specific example of the send-out amount determined in advance includes a send-out amount that brings the hook 30 onto the wheeled platform 2.

The control device 60 may cause the first winder 10A and the second winder 10B to be the manual state to place the luggage 3 on the wheeled platform 2. When the control device 60 causes the first winder 10A and the second winder 10B to be the manual state, the wire 20 is drawn out by a load of the luggage 3. Accordingly, the luggage 3 is placed on the wheeled platform 2.

Note that, during placing of the luggage 3 on the wheeled platform 2, the stopper mechanism 500 is ongoingly in operation. Therefore, the rear gate damper 50 remains in the extended state, and the rear gate 150 is not closed by a load of the suspended luggage 3.

Next, as illustrated in FIG. 8B, after the luggage 3 is placed on the wheeled platform 2, a user removes the hook 30 from the luggage 3. The control device 60 also stops the stopper mechanism 500 and causes the rear gate damper 50 to be a contractible state. Accordingly, the rear gate 150 becomes a closeable state, and the unloading operation of the luggage 3 ends.

As described above, the luggage storing apparatus 1 unloads the luggage 3 from the luggage compartment 130 onto the wheeled platform 2 by the control device 60 controlling operation of the first winder 10A and the second winder 10B. For example, the first winder 10A winds up the one end of the wire 20 based on the wind-up amount determined in advance, and the second winder 10B sends out the other end of the wire 20 based on the send-out amount determined in advance, thus drawing out the luggage 3 from the luggage compartment 130 to the lower side of the rear gate 150 and then placing the luggage 3 on the wheeled platform 2. Accordingly, similarly to the loading operation of the luggage 3, the luggage storing apparatus 1 can place the luggage 3 on the wheeled platform 2 without contacting the bumper of the vehicle 100. Moreover, the wind-up amount and the send-out amount of the wire 20 by the first winder 10A and the second winder 10B are determined in advance. Accordingly, even the luggage 3 with various shapes or sizes can be unloaded onto the wheeled platform 2 by the luggage storing apparatus 1.

As described above, the luggage storing apparatus 1 according to this embodiment includes the first winder 10A and the second winder 10B provided to the ceiling 110 of the luggage compartment 130 or the cabin 120 of the vehicle 100. Moreover, the luggage storing apparatus 1 includes the support roller 40A, 40B, the wire 20, the hook 30, and the rear gate damper 50 (stopper mechanism 500). The support roller 40A, 40B is provided to the inner surface of the luggage compartment 130 of the rear gate 150 of the vehicle 100. The wire 20 is suspended from the first winder 10A to the second winder 10B via the support roller 40A, 40B. The hook 30 attaches the luggage 3 to the wire 20 suspended between the support roller 40A, 40B and the second winder 10B. The rear gate damper 50 (stopper mechanism 500) restricts closing operation of the rear gate 150. The first winder 10A can wind up or send out the one end of the wire 20. The second winder 10B can wind up or send out the other end of the wire 20. While the rear gate 150 is open and closing operation of the rear gate 150 is restricted by the stopper mechanism 500, the luggage storing apparatus 1 winds up the one end of the wire 20 by the first winder 10A to lift the luggage 3 to the lower side of the rear gate 150 by using the support roller 40B as a fulcrum. Then, the first winder 10A sends out the one end of the wire 20 and the second winder 10B winds up the other end of the wire 20 to take the luggage 3 into the luggage compartment 130 from the lower side of the rear gate 150. Accordingly, the luggage storing apparatus 1 can load the luggage 3 without use of a large-scale device such as a movable boom. As a result, the luggage storing apparatus 1 can be equipped in a comparatively small vehicle such as a private vehicle.

Moreover, after the luggage 3 is taken into the luggage compartment 130, the luggage storing apparatus 1 according to this embodiment sends out the one end of the wire 20 by the first winder 10A and sends out the other end of the wire 20 by the second winder 10B to place the luggage 3 in the luggage compartment 130. Accordingly, in the operation of loading the luggage 3 into the luggage compartment 130 by the luggage storing apparatus 1, a user may simply attach and detach the hook 30 to the luggage 3. That is, a user can have a reduced burden to load the luggage 3 into the luggage compartment 130.

Moreover, in the luggage storing apparatus 1 according to this embodiment, the first winder 10A and the second winder 10B are each switchable between a driven state and a manual state. In the driven state, the wire 20 is mechanically wound up or sent out by the driving device (for example, the motor). In the manual state, the wire 20 is manually drawable by a user. When the luggage 3 is suspended from the wire 20, the first winder 10A and the second winder 10B are in the driven state. Moreover, when the luggage 3 is not suspended from the wire 20, the first winder 10A and the second winder 10B are in the manual state. Therefore, a user can easily draw out the wire 20 in the manual manner from the first winder 10A and the second winder 10B and attach the wire 20 to the luggage 3.

Although a certain embodiment of the disclosure is described above with reference to the accompanying drawings, the disclosure is not limited to the embodiment. It will be apparent to those skilled in the art that various changes or corrections may be conceivable without departing from the scope of the claims, and it is to be understood that they also fall within the scope of the disclosure.

Although the embodiment describes the example of the rear gate damper 50 including the stopper mechanism 500, the rear gate damper 50 is not limited to this example. For example, the stopper mechanism 500 may be provided separately from the rear gate damper 50. In this case, the stopper mechanism 500 may be, for example, a bar-shaped member that is attached manually between the rear gate 150 in the open state and the vehicle body. When the luggage 3 is suspended from the wire 20, and force is applied by a load of the luggage 3 in a direction to close the rear gate 150, the bar-shaped member serves like a tension rod and can support the rear gate 150 not to be closed.

The embodiment describes, but not limited to, the example in which the wind-up amount or the send-out amount of the wire 20 by the first winder 10A and the second winder 10B is determined in advance. For example, a sensor that detects a position of the luggage 3 may be provided, and the wind-up amount and the send-out amount of the wire 20 by the first winder 10A and the second winder 10B may be determined in accordance with the position of the luggage 3 detected by the sensor in real time. Here, the sensor that detects the position of the luggage 3 may be various types of sensors (for example, a rear sensor) provided to the vehicle 100 in advance. In this case, the control device 60 can communicate with the vehicle 100, receive position information of the luggage 3, and appropriately adjust the wind-up amount and the send-out amount of the first winder 10A and the second winder 10B based on the received position information of the luggage 3. This enables efficient carriage of the luggage 3 in accordance with the size and shape of the luggage 3.

According to the disclosure, luggage can easily be stored in a luggage compartment, with a simple configuration without use of a movable boom.

1. A luggage storing apparatus configured to store luggage into a luggage compartment of a vehicle, the luggage storing apparatus comprising:
a first winder provided to a ceiling of the luggage compartment or a cabin of the vehicle;
a second winder provided to the ceiling;
a support member provided to an inner surface of a rear gate of the vehicle;
a string-shaped member suspended from the first winder to the second winder via the support member;
an attachment member configured to attach the luggage to the string-shaped member suspended between the support member and the second winder; and
a stopper mechanism configured to restrict closing operation of the rear gate, wherein
the first winder is configured to wind up or send out a first end of the string-shaped member,
the second winder is configured to wind up or send out a second end of the string-shaped member, and
the first winder and the second winder are configured such that while the rear gate is open and the closing operation of the rear gate is restricted by the stopper mechanism, the first winder winds up the first end of the string-shaped member to lift the luggage to a lower side of the rear gate by using the support member as a fulcrum, and then the first winder sends out the first end of the string-shaped member and the second winder winds up the second end of the string-shaped member to take the luggage into the luggage compartment from the lower side of the rear gate.

2. The luggage storing apparatus according to claim 1, wherein the first winder and the second winder are configured such that after the luggage is taken into the luggage compartment, the first winder sends out the first end of the string-shaped member and the second winder sends out the second end of the string-shaped member to place the luggage in the luggage compartment.

3. The luggage storing apparatus according to claim 2, wherein the first winder and the second winder are each switchable between a driven state and a manual state, the driven state being a state in which the string-shaped member is mechanically wound up or sent out by a driving device, the manual state being a state in which the string-shaped member is manually drawable by a user,
the first winder and the second winder are configured to be in the driven state when the luggage is suspended from the string-shaped member, and
the first winder and the second winder are configured to be in the manual state when the luggage is not suspended from the string-shaped member.

4. A luggage storing apparatus configured to store luggage into a luggage compartment of a vehicle, the luggage storing apparatus comprising:
at least one processor;
a first winder provided to a ceiling of the luggage compartment or a cabin of the vehicle;
a second winder provided to the ceiling;
a support member provided to an inner surface of a rear gate of the vehicle;
a string-shaped member suspended from the first winder to the second winder via the support member;
an attachment member configured to attach the luggage to the string-shaped member suspended between the support member and the second winder; and
a stopper mechanism, wherein
the at least one processor is configured to:
while the rear gate is open and the at least one processor causes the stopper mechanism to restrict closing operation of the rear gate, cause the first winder to wind up a first end of the string-shaped member to lift the luggage to a lower side of the rear gate by using the support member as a fulcrum; and
then cause the first winder to send out the first end of the string-shaped member and cause the second winder to wind up a second end of the string-shaped member to take the luggage into the luggage compartment from the lower side of the rear gate.
